(19) United States
(12) Patent Application Publication
(10) Pub. No.: US 2006/0251861 A1
(43) Pub. Date: Nov. 9, 2006

(54) Device and method for producing insulation elements

(76) Inventors: Andreas Muth, Mannheim (DE); Andreas Rieger, Waltrop (DE); Jens Perner, Neustadt (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/539,152

(22) PCT Filed: Dec. 17, 2003
(86) PCT No.: PCT/EP03/14421

§ 371 Date: Oct. 31, 2005

(30) Foreign Application Priority Data
Dec. 18, 2002 (DE) 102 59 336.1

(51) Int. Cl. B29C 59/02; B32B 3/00

(52) U.S. Cl. 428/156; 264/284; 425/371; 428/218; 428/182

(57) ABSTRACT

This invention relates to a device and a method for producing insulation elements made of mineral wool, such as rock wool or glass wool, that contains curable binder, and to corresponding insulation elements having a non-rectangular cross-sectional profile.

This invention relates to a device according to the preamble of claim 1, a method according to the preamble of claim 12 and an insulation element according to the preamble of claim 16.

Insulation elements made of mineral wool such as rock wool or glass wool, which are provided with a binder that bonds the mineral fibers together on curing, have been known for a long time. Insulation elements of this kind have proved their value in practice and are used in a large number of applications. They possess particularly good thermal insulation properties, are inexpensive, and easy to process.

Insulation elements of this kind are used, for example, to insulate flat roofs with low roof pitch. Since the roof covering, such as the high-polymer or bituminous roof sheeting used for the roof skin, has to be applied directly above the insulation material in the case of flat roofs of this kind, the insulation panels must have the necessary gradient to ensure effective rainwater run-off from the sloping roof.

To this end, insulation panels, which are usually of rectangular cross section, are fabricated suitably according to the prior art by cutting or milling them into the desired shape so as to produce an appropriate wedge shape with a gradient. Depending on the batch size, this type of fabrication can be relatively expensive. Whereas material loss due to cutting and milling waste can usually be limited by utilizing this waste as recycling material, the dust caused by processing of this kind must as a rule be extracted and disposed of. The additional technical facilities and the extra time needed increase the price of the product. Generally speaking, production of the mineral wool preform by means of downstream machining processes (cutting, grinding, milling, introduction of folds, etc.) causes additional costs which are then allocated to the respective products.

It is also known from the prior art (DE 43 19 340 C1) how depressions can be generated in an uncured insulation blanket by providing an embossing or molding unit upstream of the curing oven, said molding unit being formed by oppositely disposed pressure belts with calotte-shaped segments having the shape of the desired depressions. The desired depressions are thus introduced into the insulation blanket while it still wet, and then, following the curing process, are filled with mineral bodies by way of which marlcs are generated to indicate the positions for screw anchors in the insulation blanket or panel. The U.S. Pat. No. 4,608,108 describes the use of molding rolls located upstream of the curing oven to produce a decorative, textured surface in an insulation blanket while it is still wet. This decorative textured pattern thus formed in the immediate surface region of the surface is retained after curing. In both the aforementioned cases, suitable embossing or molding units must be installed upstream of the curing oven, and the relief pattern is introduced into the uncured material while it is still wet. However, on account of the inherent resilience of a mineral wool blanket, the relief pattern introduced ahead of the tunnel furnace is, at least to some extent, lost again, so that secondary finishing is necessary.

The object of this invention is thus to provide a method and a device for producing insulation elements made of mineral wool, by means of which insulation elements can be readily shaped inexpensively “on line”, without the need for machining or other secondary finishing processes.

This object is established by a device having the features of claim 1 and a method having the features of claim 12. Additional subject matter of this invention is a mineral-wool insulation element having the features of claim 17. Useful developments of the invention form the subject matter of the dependent claims.

According to the invention, the interior of the curing oven is provided with a molding device which, while reducing the cross section of the gap through which the insulation material is transported within the curing oven and compacting the insulation material or insulation blanket as it passes through, influences the insulation material to such effect that permanent impressions and/or deformations are produced therein. The fact that the impressions and/or deformations in the insulation material are formed inside the curing oven ensures that they are formed exactly as desired with great ease, that is, perfectly in accordance with the profile of the molding device and, in principle, in a manner identical to embossing. This is because the insulation material is cured at the same time that it is pressure-molded; in other words, as the impressions or deformations are formed, their shape is “frozen” by the immediate curing process. As a result, secondary finishing—which is generally costly and time-consuming—can be dispensed with. The invention provides for the use of suitable molding belts, molding rolls or other compacting members within the curing oven, each of these being located at the place where the corresponding impression or deformation is to be produced. Since the impression is produced in an area where curing is not fully complete, a certain amount of material displacement occurs within the worked insulation blanket as a result of compaction; this helps to equalize the density over the cross section of the insulation material despite the compaction that has been effected. This invention is based on the idea of integrating the shaping process in the production process for the insulation body; more specifically, it is based on the idea of integrating the shaping process in the production process at the stage where the insulation material cures. At this stage, it is still easily possible to confer on the insulation material a specified cross-sectional profile that deviates from the original rectangular shape of the uncured mineral wool (e.g. a wedge shape, a rectangular shape with grooves, chamfered portions, etc.).

According to the invention, the insulation material, comprising mineral wool such as rock wool or glass wool, is molded inside the curing oven by a molding device into a shape whose cross section can differ in every conceivable way from the hitherto standard rectangular shape. To this end, it is merely necessary to provide a corresponding molding element in the device for manufacturing the thermal insulation elements, said molding element generating the desired cross-sectional profile by means of contact, especially pressure contact, of the molding element's molding surface with the insulation material to be molded.

To produce insulation elements of this kind from mineral wool and to carry out the corresponding process, hitherto known devices can easily be modified or retrofitted. Basically, there are two different approaches here: either the existing components can be suitably rearranged, or components can readily be added.

Generally, a device for the production of insulation elements from mineral wool is assembled such that the curable-binder-containing mineral fibers are deposited on a conveyor and subsequently transported into a curing oven, in this case a tunnel furnace. In the tunnel furnace, a compacting and guiding unit is usually disposed opposite the conveyor unit in such manner that the insulation material to be cured is moved between the conveyor unit and the compacting and guiding unit. The insulation material may be compacted further during this stage or may simply be guided between the two units. Devices like this can readily be modified according to the invention by designing the conveyor unit and the compacting and guiding unit, which are engineered as endless loops, such that they can be arranged with different inclinations relative to the conveying plane, that is, rotated about the longitudinal conveying axis. This produces an angle between the principal surfaces of the conveyor unit and of the compacting and guiding unit, so that the gap or space between the conveyor unit and the compacting or guiding unit can be wedge-shaped, triangular shaped, etc.

Additional molding elements can also be provided, which can be arranged, for example, in the plane of the conveyor unit and/or opposite the conveyor unit and/or to the side of the conveyor unit on one or both sides, thus making it possible to mold all sides of the insulation element.

In the case of this variant, it is especially beneficial to design appropriate molding elements as attachable elements, for example in the form of strips, which can be attached to the conveyor unit and/or to the compacting and guiding unit, especially in the tunnel furnace. To permit rapid and efficient modification of the device, the attachable elements are preferably provided with quick-release closures that allow rapid fitting of the attachable elements to the conveyor unit and/or compacting and guiding unit.

The attachable elements are preferably designed in a similar manner to conveyors known per se, by means of which the wet insulation material is transported into and through the curing oven. Conveyors of this kind are usually endless loops, or endless loops arranged in tandem, which are provided with openings or perforations to allow compaction by means of a pressurized-air supply, and, within the curing oven, curing by means of a hot-air supply. Within the curing oven, the conveyors are usually formed from grating segments that are hinged at their ends and allow the inflow of hot air to the insulation material. For this reason, it is to advantage if the conveyor units and/or compacting and guiding units within the curing oven are likewise provided with appropriate openings and perforations, or ventilation channels, it also being expedient to design the individual elements in segments that can be hinged together to form a loop conveyor. In particular, the attachable elements are engineered as metal components in the form of gratings, that is, provided with perforations or ventilation channels, and are preferably made of heat-resistant materials. It is to advantage to have the molding devices, especially in the form of attachable elements, rolls, or the like, arranged at the feed end, i.e. in the anterior section of the curing oven, because this is where the curing process begins and where the formation of impressions and/or deformations can be effected easily and without damaging the fibers. If the molding device, e.g. the attachable elements, is engineered to extend a long way into the curing oven, or, as is particularly preferable, to the end of the curing oven, the desired impressions and/or deformations are especially true to shape; they are, so to speak, the identical match of the attachable elements and the like. The attachable elements, in particular, are also designed as segments so that they can move freely around the idle rolls when engineered as endless loops. Additionally, the molding or attachable elements can have any cross-sectional profile desired, for example a rectangular, triangular, trapezoidal shape, etc., so that corresponding grooves can be formed in the insulation material. Depending on how the molding devices are designed, it is also possible to produce pictograms, circular depressions and the like, as well as impressions that can be used, for example, for product markings.

It goes without saying that the features of the described device can be combined in a great variety of ways to produce the desired cross-sectional profile for the insulation element. In particular, by using a variety of molding elements, together or alone, immediately adjacent or arranged sequentially in different sections of the device, a surface contour can be obtained that varies in the transport direction with the section-wise variation in cross-sectional profile. In particular, additional components described here—such as additional molding elements at the sides—can also be provided.

The production process according to the invention has shown that the properties of products made in this way are superior to those of insulation elements that are of comparable cross-sectional profile but are made by prior art processes involving machining steps.

Due to contact between the insulation material to be molded and the molding surface of the molding element, the insulation material is compacted to different degrees depending on its cross-sectional profile; as a result, the finished insulation element has areas of high apparent density and areas of low apparent density depending on its thickness. The useful effect of this is that in thinner areas, the insulation elements have a higher apparent density and thus greater strength, while in very thick areas, where high strength or stability is not required, they have a lower apparent density. With wedge-shaped insulation elements for sloping roofs, for example, the effect is such that the strength of the insulation element is higher at the tip of the wedge than at the opposite end. Since it is precisely the thin area at the tip of the wedge that needs additional strength, insulation elements made in this way display preferable properties. By contrast, wedge-shaped mineral-wool insulation elements produced by prior art processes involving machining steps have a uniform apparent density.

Additional advantages, characteristics and features of this invention become clear from the following detailed description of embodiments and the references to the enclosed drawings, which are of purely diagrammatic nature.

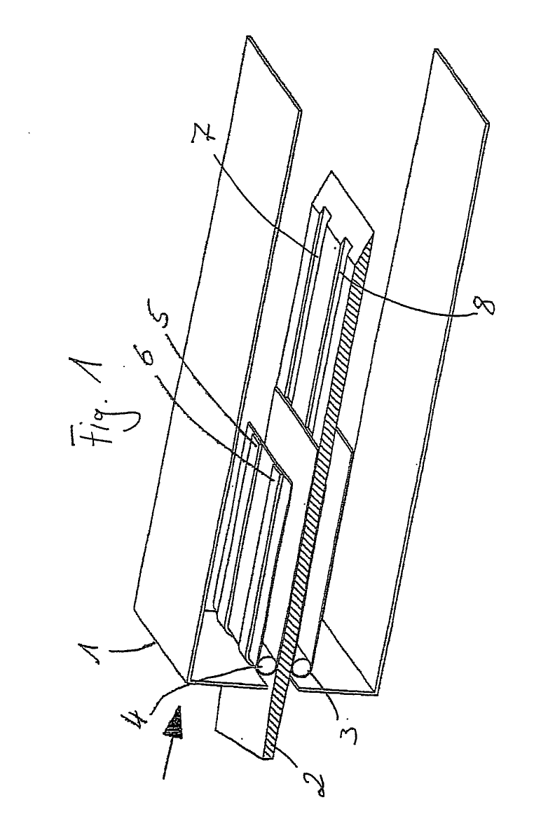

FIG. 1 shows a perspective view of a device for producing insulation elements shaped according to the invention;

FIG. 2 shows a cross section through an insulation element shaped according to the invention;

FIG. 3 shows a perspective view of the insulation element of FIG. 2;

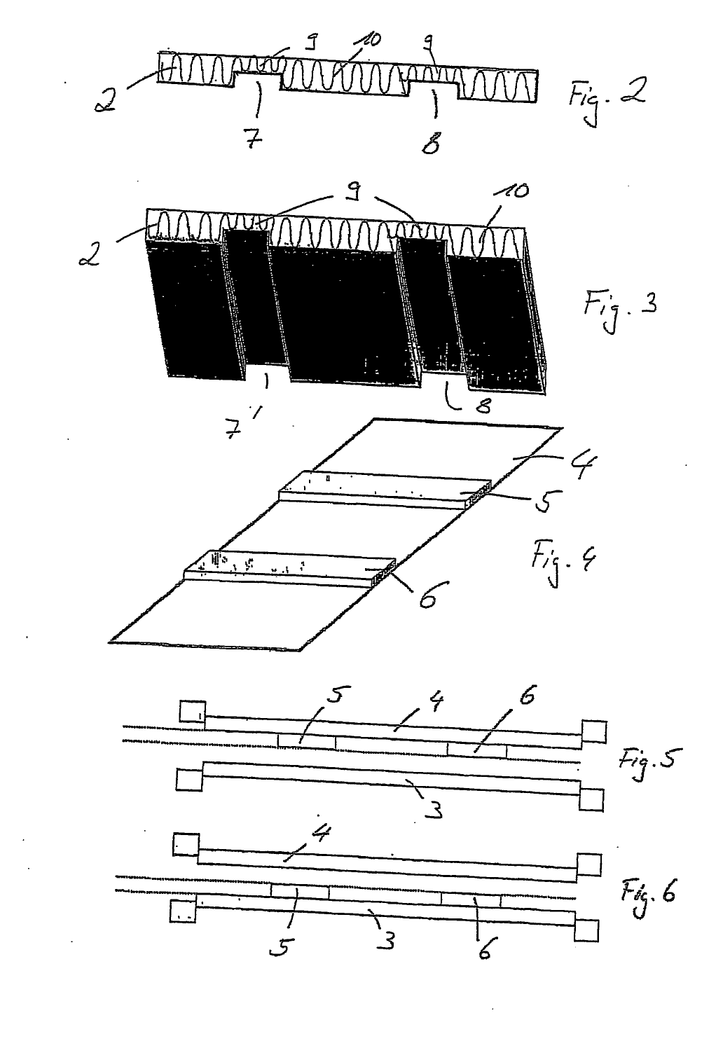

FIG. 4 shows a perspective view of apart of the device of FIG. 1;

FIG. 5 shows a cross section through a part of the device of FIG. 1;

FIG. 6 shows a cross section through an alternative version of the device of FIG. 5;

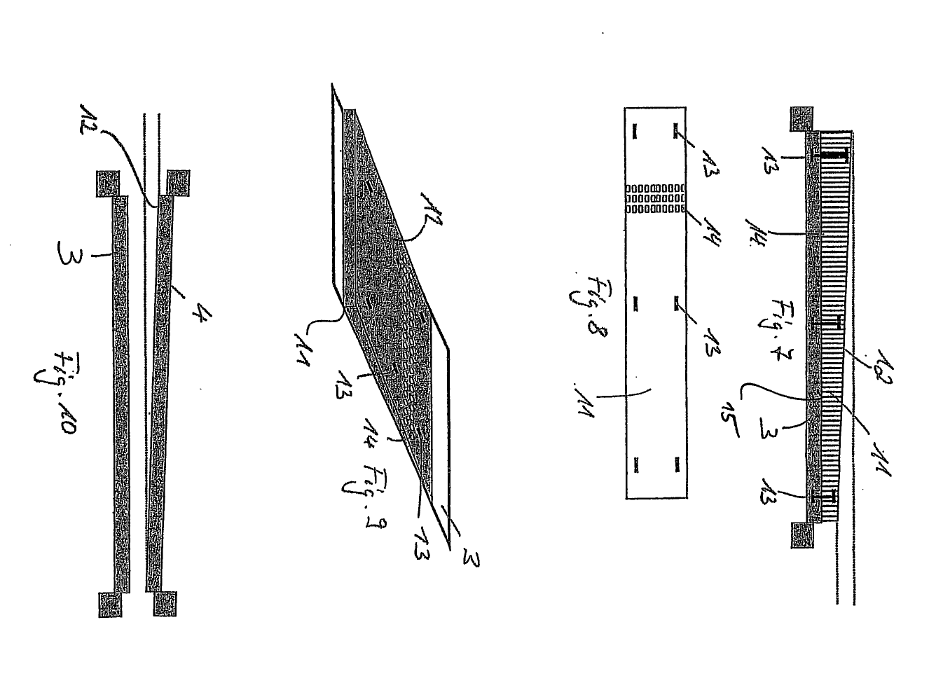

FIG. 7 shows a partial cross-sectional view of another embodiment of a device for producing the insulation elements shaped according to the invention;

FIG. 8 shows a top view of a part of the device shown in FIG. 7;

FIG. 9 shows a perspective view of the device of FIG. 7;

FIG. 10 shows a cross-sectional view of another embodiment of a device for producing the insulation elements according to the invention.

FIG. 1 shows a perspective view of a tunnel furnace 1 into which a mineral-wool insulation blanket 2 is being introduced in the direction indicated by the arrow. This insulation blanket 2 is supported on a conveyor unit that is not shown. Before it enters the tunnel furnace 1, the insulation blanket 2 consists of mineral wool and uncured binder. In the tunnel furnace 1, the mineral-wool blanket 2 is temperature-cured, the binder creating permanent cross-links between the individual mineral fibers as it cures.

In the tunnel furnace 1, a conveyor unit 3 engineered as an endless loop is provided for transporting the insulation material, i.e. the insulation blanket 2, which is on said conveyor unit. Aside from the lower endless loop 3 (conveyor unit), there is an upper endless loop 4 which is designed as a compacting and guiding unit. The upper endless loop 4 simultaneously compacts and/or guides and/or smoothes the upper surface of the mineral-wool blanket 2 while the latter is curing. The hitherto described components of the device shown in FIG. 1 correspond to the standard devices used to produce mineral-wool blankets, and are known from the prior art.

In addition to the components of the known device, however, the device shown in FIG. 1 is provided with an additional molding device having, on the upper endless loop 4, a molding element formed by the attachable elements 5 and 6 on the upper endless loop 4. The attachable elements 5 and 6 are likewise engineered as endless loops, and have a rectangular cross section. The attachable elements 5 and 6 are provided on the compacting or guiding unit 4, that is, on the upper endless loop, and are spaced apart from each other over the breadth of the insulation blanket 2. Provision of the attachable elements 5 and 6 on the upper endless loop 4 causes the insulation material in those areas of the insulation blanket 2 in which the attachable elements 5 and 6 are located on the upper endless loop 4 to be compacted more strongly during curing, so that two recesses or grooves 7 and 8 are formed in the finished insulation blanket 2. Later, after the insulation element has been cut off to form an insulation panel, a fork lift can insert its prongs into these grooves 7 and 8, thus permitting use of the panel as the lower support for a stack of panels. In this way, the support element for the stack can also be constructed as a useful insulation element, obviating the need for a pallet on which the insulation elements have to be stacked. Accordingly, there are also no empty pallets that would otherwise have to be returned or disposed of at the construction site.

In the diagram of FIG. 1, the lower endless loop 3, the upper endless loop 4 and the attachable elements 5 and 6 are depicted as continuous belts. These belts, or loops, can be formed especially by strip-like elements which, in practice, are preferably made of high-temperature steel. The loops accordingly have to be subdivided into suitable hinged segments so that they can move freely around the idle rolls. It is expedient to engineer these segments such that they allow the passage of hot air (grating, perforations, channels).

FIG. 2 shows a cross section through the finished product, for example the finished insulation panels 2 obtained by cutting them off the insulation blanket. This diagrammatic, cross-sectional view shows especially clearly that areas of high apparent density 9 are to be found in the area of the grooves 7 and 8, while in the areas where the insulation panel 2 is thicker, that is, where it has not been additionally compacted by formation of grooves 7 and 8, the apparent density is lower (areas with lower apparent density 10).

FIG. 3 shows a perspective view of the insulation panel 2 with grooves 7 and 8. Here too, the areas of high apparent density 9 and those of low apparent density 10 are indicated diagrammatically.

FIG. 4 is a perspective view of part of the molding device and clearly illustrates how the molding device is designed by arrangement of the attachable elements 5 and 6 on the upper endless loop 4, or the compacting and guiding unit 4. Aside from the profile given in this embodiment to the attachable elements 5 and 6, namely a profile of rectangular cross section, a wide variety of shapes for the attachable elements 5 and 6 is naturally conceivable, including triangles, trapezoids, semicircles and the like.

It is likewise conceivable to provide the attachable elements 5 and 6 not (only) on the upper endless loop 4, that is, on the compacting and guiding unit 4, but to provide them additionally or alternatively on the conveyor unit 3. These variants are shown in FIG. 5 and 6 as cross-sectional views.

Another embodiment of a molding element 11, engineered as attachable element, can be seen in FIG. 7, which shows a partial cross-sectional view of a part of a device for producing insulation panels according to the invention. In this embodiment, the molding element consists of a single member which extends over the entire width of, for example, the conveyor unit 3. The height of the molding element 11 decreases across the breadth thereof, so that the molding surface 12 is inclined with respect to the conveyor unit 3 or to the original conveying plane 15 of the conveyor unit 3. This wedge-shaped design of the molding element 11 or attachable element 11 produces a wedge-shaped thermal insulation element whose principal surfaces are mutually inclined, i.e. subtend an angle. Insulation elements of this nature are especially suitable for the insulation of sloping roofs, roof flashings, valley roofs etc., where the insulation panels need a suitable surface incline of 2 to 5% in order to ensure that rainwater will run off to the roof outlets. Thermal insulation panels of this kind are readily manufactured with the devices shown in FIG. 7 to 10.

As is also evident from FIG. 7, the attachable element 11 is connected with the conveyor unit 3 via a plurality of quick-release closures 13. A wide variety of such closures is available, which ensure secure connection of the attachable element 11 with the conveyor unit 3 and also permit rapid exchange of the attachable elements. Latch-type closures, snap closures and bayonet catches have proved especially suitable, while screwed closures are also possible.

FIG. 8 shows a top view of part of the device of FIG. 7. Only some of the channels 14 shown in FIG. 7 are shown here, although in reality they extend over the entire attachable element 11. The perforations or conduits 14 serve as channels for the hot air that is normally blown through the conveyor unit 3, i.e. the lower endless loop 3, or the upper endless loop 4 in a tunnel furnace 1 in order to cure the mineral wool. The device or part thereof shown in FIG. 7 and 8 is shown again in FIG. 9 from a different perspective. This once again illustrates how, on account of the attachable element 11 being wedge-shaped, a molding surface 12 is formed that is inclined toward the usually existent conveying plane 15 of the conveyor unit 3, so that the insulation panels thus produced are likewise wedge-shaped.

Another embodiment for the production of wedge-shaped thermal insulation elements is shown in FIG. 10. This embodiment has no attachable elements. Instead, the entire upper endless loop 4 is inclined toward the conveyor unit 3, so that here too, a sloping molding surface 12 is obtained. This embodiment requires provision only of the necessary means for supporting the upper endless loop in a sloping position, and for adjusting the angle of slope. In the same way, of course, means can be provided for adjusting the lower endless loop, or the conveyor unit 3, in a similar manner.

1-19. (canceled)

20. A device for producing insulation elements made of mineral wool containing a curable binder from insulation material having a rectangular cross section, comprising:
a conveyor configured to having the insulation material deposited thereon prior to curing; and
a curing oven configured to have the insulation material transported thereto via the conveyor, the curing oven having a molding device therein;
the molding device reducing a cross section of a gap through which the insulation material is transported within the curing oven and compacting the insulation material as it passes therethrough; and
the molding device being configured to provide at least one permanent impression and/or at least one deformation in the insulation material.

21. The device of claim 20, wherein:
the curing oven comprises a tunnel furnace.

22. The device of claim 20, wherein:
the molding device is integrated in a conveyor unit within the curing oven, the conveyor unit comprising at least one first molding element to form the at least one permanent impression and/or at least one deformation, during which process, as a result of contact with a molding surface of the at least one first molding element, the insulation material to be molded assumes a cross-sectional profile that deviates from the rectangular cross section of the insulation material entering the molding device.

23. The device of claim 22, wherein:
the at least one first molding element is configured to contact the insulation material with a pressure contact.

24. The device of claim 22, wherein:
the molding device has at least one second molding element opposite the at least one first molding element.

25. The device of claim 22 wherein:
the at least one molding element comprises at least two molding elements.

26. The device of claim 22, wherein:
the molding device further includes at least one lateral molding element.

27. The device of claim 22, wherein:
the first molding element is formed by a compacting and guiding unit, which, together with the conveyor unit, compacts the insulation material or transports it at an upper side.

28. The device of claim 27, wherein:
the compacting and guiding unit comprises a flight belt.

29. The device of claim 24, wherein:
the first molding element and/or the second molding element are engineered as attachable elements for the conveyor unit or a compacting and guiding unit, which, together with the conveyor unit, compacts the insulation material or transports it at an upper side.

30. The device of claim 29, wherein:
the attachable elements and the conveyor unit are engineered as metal components that have the form of gratings or are provided with ventilation channels.

31. The device of claim 30, wherein:
the components are made of heat-resistant materials.

32. The device of claim 30, wherein:
the components are segmented.

33. The device of claim 29, wherein:
the attachable elements for attachment to the conveyor and/or compacting and guiding unit have quick-release closures.

34. The device of claim 24, wherein:
the first and/or second molding element is arranged such that with respect to a conveying plane of the conveyor unit, its molding surface is inclined about a longitudinal transport axis.

35. The device of claim 20, wherein:
the molding element of the molding device is engineered as an endless loop.

36. The device of claim 35, wherein:
the endless loop includes a plurality of successive segments.

37. The device of claim 20, wherein:
the molding element is engineered such that a differing degree of compaction is obtained over a breadth of the molding surface.

38. The device of claim 20, wherein:
the molding element has a contoured molding surface.

39. The device of claim 38, wherein:
the contoured molding surface comprises an inclined planar surface.

40. The device of claim 38, wherein:
the contoured molding surface comprises grooves and/or projections.

41. A method of producing insulation elements made of mineral wool containing curable binder, comprising:
depositing insulation material on a conveyor;
curing and transporting the insulation material through a curing oven;
subjecting sections of the insulation material to controlled compaction in such a manner that at least one permanent impression and/or deformation is produced in the insulation blanket while the insulation material is curing during its passage through the curing oven.

42. The method of claim 41, wherein:
the curing oven comprises a tunnel furnace.

43. The method of claim 41, wherein:
the mineral wool is rock wool.

44. The method of claim 41, wherein:
the mineral wool is glass wool.

45. The method of claim 41, further including:
providing the insulation material with a non-rectangular cross-sectional profile before or during curing.

46. The method of claim 45, wherein:
the cross-sectional profile comprises at least one depression or projection.

47. The method of claim 46, wherein:
the cross-sectional profile of the insulation element displays two parallel recesses in one surface.

48. The method of claim 41, wherein:
during the step of subjecting sections of the insulation material to controlled compaction, the insulation material is compacted to varying degrees, whereby a density within the insulation elements varies accordingly.

49. An insulation element comprising:
mineral wool having a non-rectangular cross-sectional profile and having areas of different density.

50. The insulation element of claim 49, wherein:
the mineral wool varies in height over the cross-sectional profile.

51. The insulation element of claim 49, wherein:
the insulation element has a higher density in thinner areas than in thicker areas.

52. The insulation element of claim 49, wherein:
the cross-sectional profile of the insulation element displays, in one surface, two parallel recesses in an area of which the density is higher than in very thick areas.
